(19) United States
(12) Patent Application Publication
(10) Pub. No.: US 2024/0272287 A1
(43) Pub. Date: Aug. 15, 2024

(54) FMCW LIDAR, LIGHT PATH CONVERTER MODULE THEREOF, AND DETECTION METHOD THEREFOR

(71) Applicant: HESAI TECHNOLOGY CO., LTD., Shanghai (CN)

(72) Inventors: Zhengqing PAN, Shanghai (CN); Kai SUN, Shanghai (CN); Shaoqing XIANG, Shanghai (CN)

(21) Appl. No.: 18/647,513

(22) Filed: Apr. 26, 2024

Related U.S. Application Data
(63) Continuation of application No. PCT/CN2022/093560, filed on May 18, 2022.

(30) Foreign Application Priority Data
Oct. 26, 2021 (CN) 202111248881.5

(51) Int. Cl. G01S 7/4911; G01S 7/481; G01S 17/32

(52) U.S. Cl. CPC G01S 7/4911; G01S 7/4814; G01S 7/4817; G01S 17/32

(57) ABSTRACT

A light path converter module includes at least one first port and multiple second ports. The at least one first port is coupled to a light emitter module. The multiple second ports are distributed at least along a first direction and are arranged on a focal plane of an emitting optical component of the FMCW LiDAR. Light signals outputted from different second ports being emitted at different angles after running through the emitting optical component. The light path converter module is configured to receive the light signal inputted from the first port and select one or more of the second ports for outputting the light signal.

### CROSS-REFERENCE TO RELATED APPLICATIONS

This application is a continuation of International Application No. PCT/CN2022/093560, filed on May 18, 2022, which claims priority to Chinese Patent Application No. 202111248881.5, filed on Oct. 26, 2021. The disclosures of the aforementioned applications are hereby incorporated by reference in their entireties.

### TECHNICAL FIELD

This disclosure relates to the technical field of optical detection, and particularly relates to FMCW LiDARs, light path converter modules of FMCW LiDARs, and detection methods for FMCW LiDARs.

### BACKGROUND

LiDARs based on Frequency Modulated Continuous Wave (“FMCW”) have attracted more and more attention. The FMCW LiDAR can emit frequency modulated continuous laser as probe laser. There can be some frequency shift between an echo signal reflected from an obstacle and a corresponding light signal. The frequency shift can be measured to achieve space detection.

As accuracy requirements are higher and higher, a higher number of beams of a LiDAR can be beneficial. The angular resolution of the LiDAR can be improved.

Regarding the LiDAR, a light source and a corresponding detector can be typically termed as a “beam,” multiple light sources and multiple corresponding detectors can be used to form a multibeam radar. The multiple light sources can sequentially emit probe laser at different angles for detection. The number of light sources is increased, so that the LiDAR can reduce an angle between two probe laser beams with adjacent space angles for a same field range. In such a case, the angular resolution can be improved.

However, a FMCW LiDAR using coherent detection has higher requirements for the light source, such as narrow beam width. The beam width can represent a full width at half maximum of an emission spectrum of the laser light source (e.g., a width between two frequencies corresponding to half peak height). To narrow the beam width of the light source and improve coherence of the detection signal, an external cavity feedback device can be typically used in the light source for frequency selection, so that light at a particular frequency/wavelength can be outputted. In addition, to improve distance measurement capability of the LiDAR, an amplifier can be beneficial for each light source to enhance the light power. In this way, the FMCW LiDAR has a complex light source structure, high light source costs, and a large volume. Therefore, if the number of beams of the FMCW LiDAR is increased by increasing the number of light sources, the FMCW LiDAR can have very high costs and a too large volume.

Therefore, how to not only increase the number of beams of a FMCW LiDAR but also reduce the hardware costs can be a challenge.

### SUMMARY

This disclosure provides FMCW LiDARs, light path converter modules of FMCW LiDARs, and detection methods for FMCW LiDARs. In such a case, the number of beams of the FMCW LiDAR can be improved and hardware costs of the FMCW LiDAR can be effectively reduced.

This disclosure provides a light path converter module for a FMCW LiDAR. The light path converter module is coupled to a light emitter module. The light path converter module is configured to receive and output a light signal emitted from the light emitter module. The light signal is frequency modulated continuous laser. The light path converter module includes at least one first port and multiple second ports. The at least one first port is coupled to the light emitter module. The multiple second ports are distributed at least along a first direction and are arranged on a focal plane of an emitting optical component of the FMCW LiDAR, light signals outputted from different second ports being emitted at different angles after running through the emitting optical component. The light path converter module is configured to receive the light signal inputted from the first port and select one or more of the second ports for outputting the light signal.

Optionally, the light path converter module includes a first converter apparatus configured to perform one-port output or multiport output on the light signal emitted from the light emitter module.

Optionally, the first converter apparatus includes a first light splitter unit. The first light splitter unit includes: a first input terminal corresponding to the first port and multiple first output terminals. The first light splitter is configured to split the light signal into multiple channels and output them from the multiple first output terminals respectively.

Optionally, there is one-to-one correspondence between the first output ports and the second ports.

Optionally, the first converter apparatus further includes a light intensity regulator unit, where
the light intensity regulator unit is coupled to the multiple first output terminals, and is configured to enhance probe laser outputted from at least one of the first output terminals or attenuate probe laser outputted from other first output terminals.

Optionally, the light intensity regulator unit includes a semiconductor optical amplifier.

Optionally, the first converter apparatus includes a first optical switch assembly. The first optical switch assembly includes multiple first transmission paths located between the first port and the second ports. The first optical switch assembly is configured to transmit the light signal along at least one of the first transmission paths.

Optionally, the light path converter module further includes a second converter apparatus configured to perform one-port output or multiport output on the light signal outputted from the first converter apparatus.

Optionally, the second converter apparatus includes a second light splitter unit, the second light splitter unit includes: a second input terminal and multiple second output terminals. The second input terminal is coupled to the first converter apparatus, and the multiple second output terminals correspond to the multiple second ports respectively. The second light splitter unit is configured to split the received light signal into multiple channels, and output them from the multiple second output terminals respectively.

Optionally, the second converter apparatus includes a second optical switch assembly. The second optical switch assembly includes multiple second transmission paths located between the first converter apparatus and the second ports. The second optical switch assembly is configured to transmit the light signal along at least one of the second transmission paths.

Optionally, the light path converter module further includes an amplifier apparatus located between the light emitter module and the first converter apparatus, and is configured to amplify the light signal outputted from the light emitter module, and output the amplified light signal to the first converter apparatus.

Optionally, the light path converter module is further configured to determine one of the second ports for outputting the light signal based on a light path control signal.

Optionally, the second ports of the light path converter module are further configured to receive an echo signal of the light signal reflected from an obstacle.

Optionally, the second ports are equally spaced.

Optionally, the second ports are non-equally spaced.

Optionally, in the light path converter module, a spacing between adjacent second ports located in the center region is smaller than a spacing between adjacent second ports located in an edge region.

This disclosure further provides a FMCW LiDAR, including:
a light emitter module configured to emit a light signal, the light signal being frequency modulated continuous laser; and
the light path converter module of any one of the embodiments coupled to the light emitter module, and is configured to receive the light signal and select one or more second ports for outputting the light signal.

Optionally, a conversion frequency of the light path converter module is configured based on a preset angular resolution and a scanning frequency of the FMCW LiDAR.

Optionally, the FMCW LiDAR further includes:
a frequency mixer module configured to mix local oscillator light with an echo signal of the light signal reflected from an obstacle to obtain a beat frequency signal, where the local oscillator light is partial light isolated from the light signal;
a light receiver module configured to perform photoelectric conversion on the beat frequency signal; and
a data processor module configured to perform sampling and data processing on an electrical signal outputted from the receiver module.

Optionally, there is one-to-one correspondence between the frequency mixer module and the second ports of the light path converter module.

Optionally, the FMCW LiDAR further includes: a scanner module configured to reflect the light signal, and reflect the echo signal to the light path converter module.

Optionally, the scanner module deflects the light signal in at least a second direction, and there is an angle between the first direction and the second direction.

Optionally, the scanner module includes at least one of:
a two-dimensional scanner apparatus configured to rotate along a first rotation axis at a first frequency, and rotate around a second rotation axis at a second frequency; or
two one-dimensional scanner apparatuses, one of which is configured to rotate around the first rotation axis at the first frequency and the other one of which rotates along the second rotation axis at the second frequency;
where the first direction is perpendicular to the first rotation axis, and the second direction is perpendicular to the second rotation axis.

Optionally, the scanner module includes a one-dimensional scanner apparatus that rotates around a third rotation axis at a third frequency.

Optionally, the third rotation axis is parallel to the first direction.

This disclosure further provides a detection method for a FMCW LiDAR, including:
generating a light signal, the light signal being frequency modulated continuous laser;
selecting at least one from multiple second ports to output the light signal; where the second ports are distributed at least along a first direction; and the multiple second ports are arranged on a focal plane of an emitting optical component of the FMCW LiDAR, light signals outputted from different second ports being emitted at different angles after running through the emitting optical component;
mixing local oscillator light with an echo signal of the light signal reflected from an obstacle to obtain a beat frequency signal, where the local oscillator light is partial light isolated from the light signal;
performing photoelectric conversion on the beat frequency signal; and
performing sampling and data processing on an electrical signal obtained from the photoelectric conversion.

Optionally, the detection method further includes:
deflecting the light signal in at least a second direction, and outputting the light signal to a target space; where there is an angle between the first direction and the second direction.

Optionally, the detection method further includes:
configuring a conversion frequency of the light signal based on a preset angular resolution and a scanning frequency of the FMCW LiDAR.

In this disclosure, after a light emitter module emits a light signal, the light path converter module can receive the light signal through at least one first port coupled to the light emitter module, and can select one or more second ports arranged on a focal plane of an emitting optical component for outputting the light signal. Light signals outputted from different second ports can be shaped by the emitting optical component and be emitted at different angles; and the second ports that output the light signal are selected and switched through the light path converter module to emit the light signal at different angles for detection, equivalent to multiple “beams.” In such a case, the light path converter module can flexibly convert a light path of the light signal. The FMCW LiDAR has an ability to output multichannel light signals, and can be changed based on the requirements for the number of beams. The diversity and universality of the number of beams of the FMCW LiDAR can be improved. The structure of the light emitter module can remain unchanged, it is not necessary to increase the number of light sources. Instead, light path conversion is performed through the light path converter module. In such a case, the light emitter module of the FMCW LiDAR can use a smaller number of light sources to achieve detection using a larger number of beams. In addition, the light path converter module provided in the embodiments of this disclosure has a much smaller volume than a light emitter module including an external cavity feedback device and an amplifier, and even can be integrated on a chip, thus achieving very low device costs. In some embodiments of this disclosure, not only the number of beams of the FMCW LiDAR can be increased, but also hardware costs of the FMCW LiDAR can be effectively reduced.

### BRIEF DESCRIPTION OF DRAWINGS

To more clearly describe the technical solutions of the embodiments of this disclosure, the drawings to be used in the description of the embodiments of this disclosure or the prior art are briefly introduced below. Apparently, the drawings described below are merely some embodiments of this disclosure. For those of ordinary skill in the art, other drawings can also be obtained based on these drawings without making creative work.

FIG. 1 shows an example schematic connection diagram of a light path converter module for a FMCW LiDAR, consistent with some embodiments of this disclosure.

FIG. 2 shows a structural block diagram of a first example light path converter module, consistent with some embodiments of this disclosure.

FIG. 3 shows a structural block diagram of a second example light path converter module, consistent with some embodiments of this disclosure.

FIG. 4 shows an example structural diagram of a light intensity regulator unit shown in FIG. 3.

FIG. 5 shows a structural block diagram of a third example light path converter module, consistent with some embodiments of this disclosure.

FIG. 6 shows an example structural diagram of a first optical switch assembly shown in FIG. 5.

FIG. 7 shows a structural block diagram of a fourth example light path converter module, consistent with some embodiments of this disclosure.

FIG. 8 shows a structural block diagram of a fifth example light path converter module, consistent with some embodiments of this disclosure.

FIG. 9 shows a structural block diagram of a sixth example light path converter module, consistent with some embodiments of this disclosure.

FIG. 10 shows a structural block diagram of a seventh example light path converter module, consistent with some embodiments of this disclosure.

FIG. 11 shows a structural block diagram of a first example FMCW LiDAR, consistent with some embodiments of this disclosure.

FIG. 12 shows a structural block diagram of a second example FMCW LiDAR, consistent with some embodiments of this disclosure.

FIG. 13 shows a structural block diagram of a third example FMCW LiDAR, consistent with some embodiments of this disclosure.

FIG. 14 shows a schematic diagram of internal light path deflection of a scanning and rotating FMCW LiDAR, consistent with some embodiments of this disclosure.

FIG. 15 shows a schematic diagram of internal light path deflection of another scanning and rotating FMCW LiDAR, consistent with some embodiments of this disclosure.

FIG. 16 shows a structural block diagram of another FMCW LiDAR, consistent with some embodiments of this disclosure.

FIG. 17 shows a flowchart of a laser detection method, consistent with some embodiments of this disclosure.

### DETAILED DESCRIPTION

As can be known from the Background, increasing the number of light signal beams of a FMCW LiDAR can increase the hardware costs of the FMCW LiDAR.

To solve the above problems, this disclosure provides a light path converter module for a FMCW LiDAR. After a light emitter module emits a light signal, the light path converter module can receive the light signal through at least one first port coupled to the light emitter module, and can select one or more second ports arranged on a focal plane of an emitting optical component of the FMCW LiDAR for outputting the received light signal. The light path converter module can be used to flexibly regulate the number of light signal beams. In such a case, not only the requirements for increasing the number of beams of the FMCW LiDAR can be satisfied, but also the hardware costs of the FMCW LiDAR can be effectively reduced.

To enable those skilled in the art to more clearly understand and implement the concepts, implementation solutions, and advantages of this disclosure, detailed description are provided below with reference to the drawings and some embodiments.

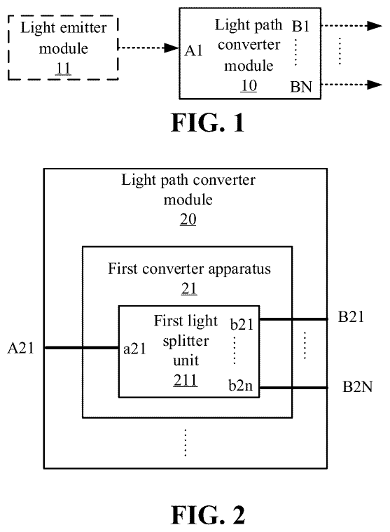

FIG. 1 shows an example schematic connection diagram of a light path converter module for a FMCW LiDAR, consistent with some embodiments of this disclosure. With reference to FIG. 1, the light path converter module 10 include a first port A1 and N second ports B1 to BN, where N is an integer greater than 1. The first port A1 is coupled to a light emitter module 11. The multiple second ports B1 to BN are distributed at least along a first direction (as shown in FIG. 1, the multiple second ports B1 to BN are distributed along a perpendicular direction). The multiple second ports B1 to BN are arranged on a focal plane of an emitting optical component of the FMCW LiDAR, and light signals outputted from different second ports are emitted at different angles after running through the emitting optical component.

The light emitter module 11 can emit frequency modulated continuous laser with a narrow beam width (e.g., the beam width is less than or equal to 1 nanometer). The structure of the light emitter module 11 can be determined based on application scenarios and requirements, and is not specifically limited in this disclosure. For example, the light emitter module 11 can include a light source, an amplifier, or the like. The light source can include: a distributed feedback laser (“DFB”), a distributed Bragg reflector (“DBR”) laser, a fiber laser, an external cavity laser, or the like.

It should be noted that, to facilitate description and understanding, in this example, the light path converter module 10 shown in FIG. 1 merely includes a first port A1 and multiple second ports B1 to BN matching the first port A1. However, when the light path converter module provided in embodiments of this disclosure is practically implemented, the light path converter module can include multiple first ports and multiple second ports matching the first ports respectively. The numbers of the first ports and the second ports of the light path converter module are not specifically limited in embodiments of this disclosure.

It should be further noted that, although in this example, the second ports B1 to BN of the light path converter module 10 shown in FIG. 1 are distributed along a perpendicular direction, the multiple second ports can be distributed along other directions (e.g., a horizontal direction) in some practical application. In addition, the multiple second ports can also be distributed in a form of a two-dimensional array along multiple directions. The distribution of the second ports is not specifically limited in embodiments of this disclosure.

Further referring to FIG. 1, after the light emitter module 11 can emit a light signal, the light signal is inputted from the first port A1 of the light path converter module 10. Then, a corresponding second port is selected from the second port B1 to the second port BN for outputting the light signal.

For example, based on a selection configuration of the second ports of the light path converter module 10, the light path converter module 10 can select a second port Bi (1≤i≤N and i is an integer) for outputting the light signal. The light path converter module 10 can also select multiple second ports for outputting the light signal. For example, a second port Bi and a second port Bj (1≤i≤N, 1≤j≤N, and j is an integer, i≠j) can be selected for outputting the light signal. The light path converter module 10 can further sequentially select corresponding second ports from the second port B1 to the second port BN for outputting the light signal, where when sequentially outputting the light signal, the light path converter module 10 can select one second port Bi each time for outputting the light signal, or can select multiple second ports (e.g., selecting the second port Bi and the second port Bj) for outputting the light signal parallelly.

Those skilled in the art can understand that the light path converter module 10 selects or switches the second ports for outputting the light signal, so that the light signal is emitted at different angles without affecting a modulation frequency of the light signal and without affecting coherent detection using the FMCW LiDAR. The FMCW LiDAR can isolate a part of light from the light signal for use as local oscillator light. The FMCW LiDAR can use the remaining part of light as probe laser, which is collimated through the emitting optical component (or a scanning mirror can be arranged for angular deflection of the probe laser), and then emitted. Echo light reflected from an obstacle can be guided to a frequency mixer, and can be mixed with the local oscillator light in the frequency mixer, to determine distance and speed information of the obstacle based on the difference frequency between the echo light and the local oscillator light.

As can be seen from the above description, even if the light emitter module (e.g., the light emitter module 11) of the FMCW LiDAR merely includes a laser light source, the FMCW LiDAR can have an ability to output multichannel light signals through the light path converter module (e.g., equivalent to a multibeam FMCW LiDAR.)

It should be noted that the description of this example is merely schematic description. In some embodiments, the selection configuration of the second ports of the light path converter module can be regulated based on scenarios and requirements. The selection configuration of the second ports of the light path converter module is not specifically limited in this disclosure.

To sum up, the light path converter module can flexibly convert a light path of the light signal, so that the FMCW LiDAR has an ability to output multichannel light signals, and can be changed based on the requirements for the number of beams. In such a case, the diversity and universality of the number of beams of the FMCW LiDAR can be improved. Because the structure of the light emitter module remains unchanged, it is not necessary to increase the number of light sources. Instead, light path conversion is performed through the light path converter module, so that the light emitter module of the FMCW LiDAR can use a smaller number of light sources to achieve detection using a larger number of beams. In addition, the light path converter module provided in the embodiments of this disclosure has a much smaller volume than a light emitter module including an external cavity feedback device and an amplifier, and even can be integrated on a chip. In such a case, very low device costs can be achieved. Therefore, the light path converter module provided in the embodiments of this disclosure not only can increase the number of beams of the FMCW LiDAR, but also can effectively reduce hardware costs of the FMCW LiDAR.

It should be noted that in this disclosure, the first port and the second ports of the light path converter module are features named to facilitate description and understanding. In some practical application, the first ports and the second ports of the light path converter module can be implemented as input terminals and output terminals of a same optical device, or can be implemented as input terminals and output terminals of different optical devices. This is not specifically limited in this disclosure.

In some embodiments, the light path converter module can include a first converter apparatus, which can perform one-port output or multiport output on the light signal emitted from the light emitter module. The first converter apparatus can use one or a combination of more of light splitting and path switching to implement the function of light path conversion. Examples are given below for description with reference to the drawings.

FIG. 2 shows a structural block diagram of a first example light path converter module, consistent with some embodiments of this disclosure. In some embodiments, as shown in FIG. 2, the light path converter module 20 can include a first port A21, multiple second ports B21 to B2N, and a first converter apparatus 21.

For example, the first converter module 21 can include a first light splitter unit 211, where the first light splitter unit 211 can include: a first input terminal a21 and N first output terminals b21 to b2n. The first input terminal a21 can correspond to the first port A21 of the light path converter module 20, and the multiple first output terminals b21 to b2n can correspond to the multiple second ports B21 to B2N respectively.

Through the first light splitter unit 211, the light signal inputted into the first port A21 can be split into multiple channels for transmission, and the multichannel light signals can be outputted from the multiple first output terminals b21 to b2n respectively. In such a case, the first converter apparatus 21 can perform multiport output on the light signal, and the light signal can be outputted from the second ports B21 to B2N of the light path converter module 20 respectively. The embodiments can spread one light signal beam into N light signal beams.

It is understandable that, to facilitate description and understanding, in this disclosure, the first light splitter unit 211 merely includes a first input terminal a21 and multiple first output terminals b21 to b2n matching the one first input terminal. However, when the light path converter module provided in some embodiments of this disclosure is practically applied, the first light splitter unit can include multiple first input terminals and multiple first output terminals matching the first input terminals. The number of first output terminals and first input terminals of the first light splitter unit is not specifically limited in this disclosure.

The first light splitter unit can be a free-space light splitter, a fiber coupler, a planar lightwave circuit (“PLC”) directional coupler, a silicon optical multi-mode interferometer (“MMI”) coupler, a silicon optical directional coupler, or the like.

In addition, based on the application scenarios and requirements, the number and a corresponding relationship of first converter apparatuses included in the light path converter module can be set, and the number and a corresponding relationship of first light splitter units included in one of the first converter apparatuses can be set. This is not limited in this disclosure.

In some embodiments, there can be one-to-one correspondence between the first input terminals of the first light splitter unit and the first ports of the light path converter module, and there can be one-to-one correspondence between the first output terminals of the first light splitter unit and the second ports of the light path converter module.

In some embodiments, the first light splitter unit can select a light splitting device included therein based on the application scenarios and requirements. For example, the first light splitter unit can include a 1:N coupler, where the 1:N coupler can split a received light signal beam into N light signal beams in equal proportions and output them. The 1:N coupler can be a mature optical device with low costs and a small volume, and be configured to be integrated in a chip to further reduce the costs and reduce the volume of the optical device.

For example, referring to FIG. 2, the first light splitter unit 211 can split the light signal into multiple channels for transmission (e.g., splitting the light in a ratio of 1:N). In such a case, power of the light signal outputted from each of the first output terminals (i.e., any one of the first output terminals b21 to b2n) can be merely 1/N of the original light signal (e.g., the light signal inputted from the first port A21). The low light signal power can reduce the distance measurement capability of the LiDAR.

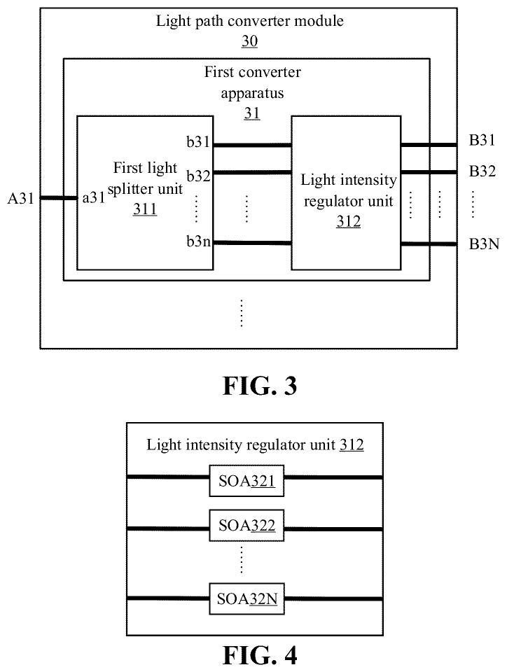

FIG. 3 shows a structural block diagram of a second example light path converter module, consistent with some embodiments of this disclosure. With reference to FIG. 3, the light path converter module 30 can include a first port A31, multiple second ports B31 to B3N, and a first converter apparatus 31. The first converter apparatus 31 can include a first light splitter unit 311 and a light intensity regulator unit 312. Therefore, when the first converter apparatus 31 of this embodiment is used, at least one second port can be selected from the multiple second ports B31 to B3N for outputting the light signal from the first port A31.

For example, the first light splitter unit 311 can include a first input terminal a31 and multiple first output terminals b31 to b3n. The first input terminal a31 can correspond to the first port A31 of the light path converter module 30. Through the first light splitter unit 311, the light signal inputted into the first port A31 can be split into multiple channels for transmission, and the multichannel light signals can be outputted from the multiple first output terminals b31 to b3n respectively.

An input terminal of the light intensity regulator unit 312 can be coupled to the multiple first output terminals b31 to b3n of the first light splitter unit 311. An output terminal of the light intensity regulator unit 312 can be coupled to the multiple second ports B31 to B3N. Through the light intensity regulator unit 312, a light signal outputted from at least one first output terminal among the multiple first output terminals b31 to b3n can be enhanced, and light signals outputted from other first output terminals can be attenuated.

The enhanced light signal can be outputted from the light intensity regulator unit 312 and continued to propagate backward, while the attenuated light signal is terminated at the light intensity regulator unit 312. Accordingly, based on a corresponding relationship between the light intensity regulator unit 312 and the multiple second ports B31 to B3N, the enhanced light signal can be outputted from at least one second port among the multiple second ports B31 to B3N. Therefore, the embodiments can spread one light signal beam into N light signal beams.

In some embodiments, the light intensity regulator unit can be coupled to each one of the multiple first output terminals of the first light splitter unit, to enhance the light signal subsequently outputted from the selected second port (e.g., enhance the light signal to the power of the original light signal or even a higher power). In such a case, the distance measurement capability of the LiDAR can be ensured or improved.

It is understandable that the number of enhanced light signals and positions of ports outputting the enhanced light signals from the light path converter module can be determined based on a corresponding relationship between the multiple second ports and the multiple first output terminals. For example, if there is one-to-one correspondence between the multiple first output terminals b31 to b3n and the multiple second ports B31 to B3N sequentially through the light intensity regulator unit 312, when the light intensity regulator unit enhances the light signal outputted from the first output terminal b31, and attenuates the light signal outputted from the first output terminals b32 to b3n, the enhanced light signal can be outputted from the second port B31.

As can be seen from the description, after the light signal is split through the first light splitter unit for multichannel output, the light intensity regulator unit can control transmissions of the multichannel light signals outputted from the first light splitter unit respectively. In such a case, the light signal can be outputted from a predetermined second port of the light path converter module.

In some practical application, the light intensity regulator unit can select a device with a light intensity regulation function included therein based on application scenarios and requirements. The structure of the light intensity regulator unit is not limited in this disclosure.

FIG. 4 shows an example structural diagram of a light intensity regulator unit shown in FIG. 3. For example, the light intensity regulator unit 312 can include: multiple semiconductor optical amplifiers (“SOA”), namely SOA321 to SOA32N in the figure.

Referring to FIG. 3 and FIG. 4, the SOA321 can be located between the first output terminal b31 and the second port B31. Similarly, through the SOA321 to the SOA32N, there can be one-to-one correspondence between the multiple first output terminals b31 to b3n and the multiple second ports B31 to B3N.

After at least one of the SOA321 to the SOA32N receives the light signal, the light signal can be enhanced or attenuated, and the enhanced light signal can be transmitted to a corresponding second port. In such a case, the light signal can be outputted from the predetermined second port.

It is understandable that, in addition to the coupling method described, the multiple SOAs, the multiple first output terminals, and the multiple second ports can also be coupled in other sequences to cause that there is a one-to-one correspondence between each pair among them. This is not limited in this disclosure.

It is further understandable that although the description provides output of the enhanced light signal from a second port, in some practical application, through the cooperation of the multiple SOAs, the multiple second ports can output the enhanced light signal. This is not specifically limited in this disclosure.

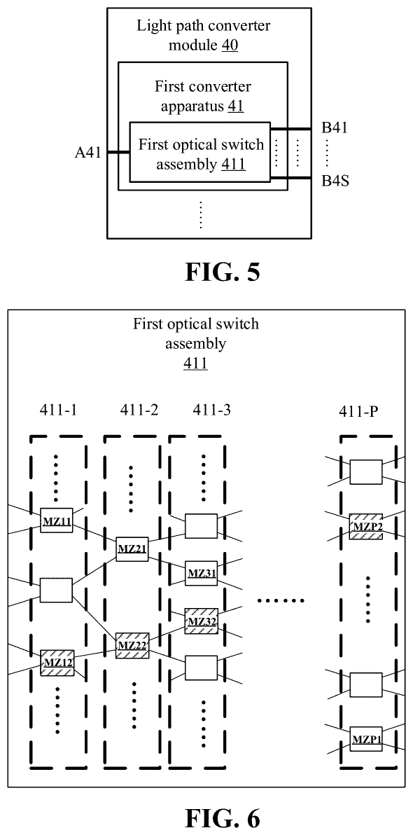

In some embodiments, a path switching method can be used for the first converter apparatus. FIG. 5 shows a structural block diagram of a third example light path converter module, consistent with some embodiments of this disclosure. As shown in FIG. 5, the light path converter module 40 can include a first port A41, multiple second ports B41 to B4S, and a first converter apparatus 41. The first converter apparatus 41 can include a first optical switch assembly 411.

The first optical switch assembly 411 can include multiple first transmission paths (not shown in FIG. 5), the multiple first transmission paths is located between the first port A41 and the multiple second ports B41 to B4S, respectively. The first optical switch assembly 411 can allow the light signal to be transmitted along at least one of the first transmission paths.

For example, the first optical switch assembly 411 can include at least one optical switch (not shown in FIG. 5), and one optical switch can provide multiple channels for the light signal, thereby forming the multiple first transmission paths. Each optical switch can be controlled based on application scenarios and requirements. In such a case, the first transmission paths can be flexibly switched. A first transmission path can be obtained to transmit the light signal. The light signal can be transmitted to a predetermined second port.

When the first converter apparatus 41 of some embodiments is used, at least one second port can be selected from the multiple second ports B41 to B4S for outputting the light signal from the first port A41.

In some embodiments, the number of input terminals of the first optical switch assembly can be not less than the number of first ports of the first optical switch assembly, to receive the light signal from a corresponding first port. The number of output terminals of the first optical switch assembly can be not less than the number of second ports of the first optical switch assembly, so that the light signal converted through the first optical switch assembly can be outputted from the corresponding second port. The number of input terminals of the first optical switch assembly can be different from the number of output terminals of the first optical switch assembly.

Optionally, to facilitate management of the number of ports, there can be a proportional relationship between the number of ports at both terminals of the first optical switch assembly. The number of input terminals and output terminals can be determined based on the application scenarios.

In some practical application, the first optical switch assembly can select an optical switch included therein based on the application scenarios and requirements. For example, the first optical switch assembly can include a Mach-Zehnder interferometer (“M-Z”) intensity modulated optical switch. The structure of the first optical switch assembly is not limited in this disclosure.

In some embodiments, the first optical switch assembly can include multiple cascaded optical switch groups, a first stage optical switch group corresponds to the first ports, and a last stage optical switch group corresponds to the second ports. Each stage optical switch group includes at least one optical switch, and an output from an optical switch of a prior stage is coupled to inputs into multiple optical switches of a next stage.

An optical switch can provide two output paths for the light signal, and the light signal inputted into the optical switch can be outputted from either one of its two output terminals. Therefore, the number of stages of the first optical switch assembly and the number of optical switches in each stage optical switch group can be configured based on requirements for the number of input terminals and output terminals of the first optical switch assembly, or requirements for the number of first transmission paths. In such a case, the multiple first transmission paths can be formed.

Based on a corresponding relationship between the first ports, the first optical switch assembly, and the second ports, a channel of a corresponding optical switch in the optical switch group can be used to obtain a first transmission path required for transmitting the light signal, so that the light signal is outputted from the predetermined second port.

Therefore, after different numbers of optical switches are cascaded, more first transmission paths and output terminals can be obtained. In such a case, different transmission requirements can be satisfied.

FIG. 6 shows an example structural diagram of a first optical switch assembly shown in FIG. 5. For example, the first optical switch assembly 411 can include multiple optical switch groups, namely an optical switch group 411-1, an optical switch group 411-2, and an optical switch group 411-3 to an optical switch group 411-P. The optical switch group 411-1 is a first stage optical switch group, the optical switch group 411-2 is a second stage optical switch group, or the like. Each optical switch in the optical switch groups 411-1 to 411-P is 2×2 (two input terminals and two output terminals) M-Z type optical switch.

Referring to FIG. 5 and FIG. 6, at least one input terminal of at least one optical switch in the optical switch group 411-1 can correspond to the first port A41 to receive a light signal; and an output terminal of an optical switch of a prior stage (e.g., each optical switch in the optical switch group 411-1) can be coupled to input terminals of multiple optical switches of a next stage (e.g., two optical switches in the optical switch group 411-2) respectively. The output terminal of the optical switch in the optical switch group 411-P can correspond to the second ports B41 to B4S.

For example, an optical switch MZ11 in the optical switch group 411-1 can receive a light signal corresponding to the first port, the optical switch MZ11 can output the light signal to an optical switch MZ21 in the optical switch group 411-2. Then the optical switch MZ21 can output the light signal to an optical switch MZ31 in the optical switch group 411-3, or the like. After multi-stage transmission, an optical switch MZP1 in the optical switch group 411-P can output the light signal to a corresponding second port.

For another example, an optical switch MZ12 in the optical switch group 411-1 receives a light signal corresponding to the first port, the optical switch MZ12 outputs the light signal to an optical switch MZ22 in the optical switch group 411-2. Then the optical switch MZ22 outputs the light signal to an optical switch MZ32 in the optical switch group 411-3, or the like. After multi-stage transmission, an optical switch MZP2 in the optical switch group 411-P can output the light signal to a corresponding second port.

It is understandable that, the description is merely schematic description. In some practical application, based on a corresponding relationship between the first ports, the first optical switch assembly, and the second ports, a corresponding optical switch can be selected to form one or more desired first transmission paths. In such a case, the light signal can be outputted from the predetermined second port.

In some practical application of a current LiDAR, distance measurement capability of the LiDAR can be constantly improved, and requirements for the number of its beams match its distance measurement capability. Therefore, the higher the number of beams of the LiDAR is, the better the LiDAR can be. In some embodiments, based on the described first converter apparatus, a second converter apparatus can be further included. The second converter apparatus can be coupled to the first converter apparatus, to perform one-port output or multiport output on the light signal outputted from the first converter apparatus. The second converter apparatus can use one or a combination of more of light splitting and path switching to implement the function of light path conversion. Examples are given below for description with reference to the drawings.

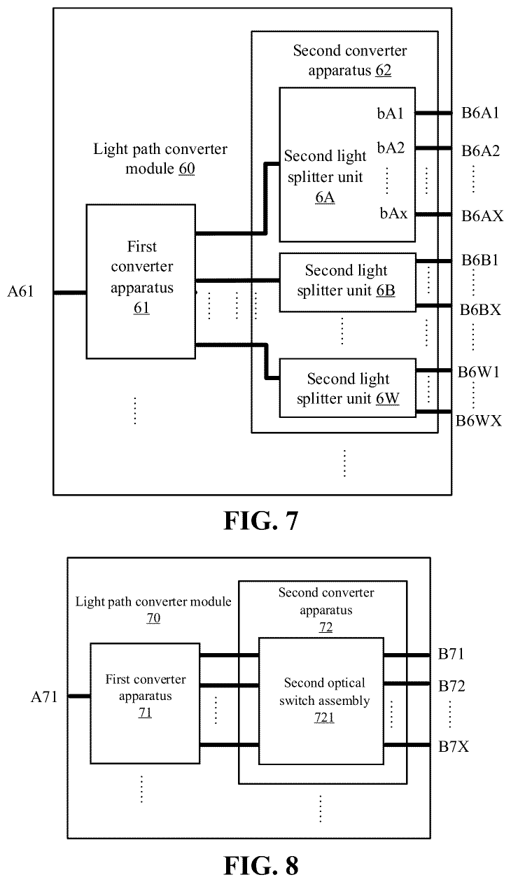

FIG. 7 shows a structural block diagram of a fourth example light path converter module, consistent with some embodiments of this disclosure. In this example, the light path converter module 60 can include: a first port A61, a first converter apparatus 61, a second converter apparatus 62, and multiple second ports B6A1-B6AX to B6W1-B6WX.

The first port A61 corresponds to the first converter apparatus 61, and the relevant description can be referred to for a structure, a connection relationship, and an implementation principle of the first converter apparatus 61, which are not repeated here.

The second converter apparatus 62 can include multiple second light splitter units, such as second light splitter units 6A to 6W in FIG. 7. The second light splitter units 6A to 6W are coupled to output terminals of the first converter apparatus 61 respectively, and second output terminals bA1 to bAx of the second light splitter unit 6A can correspond to the multiple second ports B6A1 to B6AX respectively. Similarly, a second output terminal of the second light splitter unit 6B can correspond to the multiple second ports B6B1 to B6BX respectively, . . . , and a second output terminal of the second light splitter unit 6W can correspond to the multiple second ports B6W1 to B6WX respectively.

Taking the second light splitter unit 6A as an example, after receiving a light signal, the second light splitter unit 6A can split an enhanced light signal for multichannel transmission. The second light splitter unit 6A can output the split signal from the second output terminals bA1 to bAx to the second ports B6A1 to B6AX respectively. The second light splitter unit 6A can output the light signal from the second ports B6A1 to B6AX.

Based on the number of light signal beams outputted from the first converter apparatus 61, the second converter apparatus 62 can increase the number of light signal beams by X times, where X is the number of second light splitter units.

It should be noted that, although the second light splitter units 6A to 6W schematically shown in FIG. 7 include the same number of second output terminals, in some practical application, the number of second output terminals of the second light splitter units 6A to 6W can be not exactly the same. The number of second output terminals of the second light splitter unit is not limited in this disclosure.

It should be further noted that, to facilitate description and understanding, in the above examples, the second light splitter units 6A to 6W shown in FIG. 7 only include a second input terminal and multiple second input terminals matching the one second input terminal. However, when the light path converter module provided in the embodiment of this disclosure is practically applied, the second light splitter unit can include multiple second input terminals and multiple second output terminals matching the second input terminals. The number of second output terminals and second input terminals of the second light splitter unit is not specifically limited in the embodiment of this disclosure.

It is understandable that, in addition to the corresponding sequence described in this example, the first port, the first converter apparatus, the second converter apparatus, and the second ports can also correspond to each other in other sequences, which is not limited in this disclosure.

It is further understandable that, the number and a corresponding relationship of the second light splitter units included in the light path converter module can be set based on application scenarios and requirements, and are not limited in the embodiment of this disclosure.

FIG. 8 shows a structural block diagram of a fifth example light path converter module, consistent with some embodiments of this disclosure. For example, the light path converter module 70 can include a first converter apparatus 71 and a second converter apparatus 72. The description of the relevant portions can be referred to for a structure, a connection relationship, and an implementation principle of the first converter apparatus 71, which are not repeated here.

The light path converter module 70 can include a first port A71 and multiple second ports B71 to B7X. The first port A71 corresponds to the first converter apparatus 71; the first converter apparatus 71 is coupled to the second converter apparatus 72; and the second converter apparatus 72 corresponds to the second ports B71 to B7X.

For example, the second converter apparatus 72 can include: a second optical switch assembly 721. The second optical switch assembly 721 can include multiple second transmission paths (not shown in FIG. 8) located between the first converter apparatus 71 and the second ports B71 to B7X. The second optical switch assembly 721 can allow the light signal to be transmitted along at least one of the second transmission paths. The relevant description of the above first optical switch assembly can be referred to for a structure, a connection relationship, and an implementation principle of the second optical switch assembly 721, which are not repeated here.

In some embodiments, the number of input terminals of the second optical switch assembly can be not less than the number of output terminals of the first converter apparatus, to receive a light signal outputted from the first converter apparatus. The number of output terminals of the second optical switch assembly can be not less than the number of second ports. In such a case, a light signal converted through the second optical switch assembly can be outputted from a corresponding second port. The number of input terminals of the second optical switch assembly can be different from the number of output terminals of the second optical switch assembly. In such a case, a required number of input terminals and a required number of output terminals can be obtained based on the application scenarios.

In some practical application, the second optical switch assembly can select an optical switch included therein based on the application scenarios and requirements. For example, the second optical switch assembly can include a Mach-Zehnder type optical switch. The structure of the second optical switch assembly is not limited in this disclosure.

In some embodiments, the second optical switch assembly can include multiple cascaded optical switch groups. The first stage optical switch group corresponds to an output terminal of the first converter apparatus, and a last stage optical switch group corresponds to the second ports.

Each stage optical switch group can include at least one optical switch, and an output from an optical switch of a prior stage is coupled to inputs into multiple optical switches of a next stage.

FIG. 6 and the relevant description can be referred to for a structure, a connection relationship, and a principle of multiple optical switch groups in the second optical switch assembly, which are not repeated here.

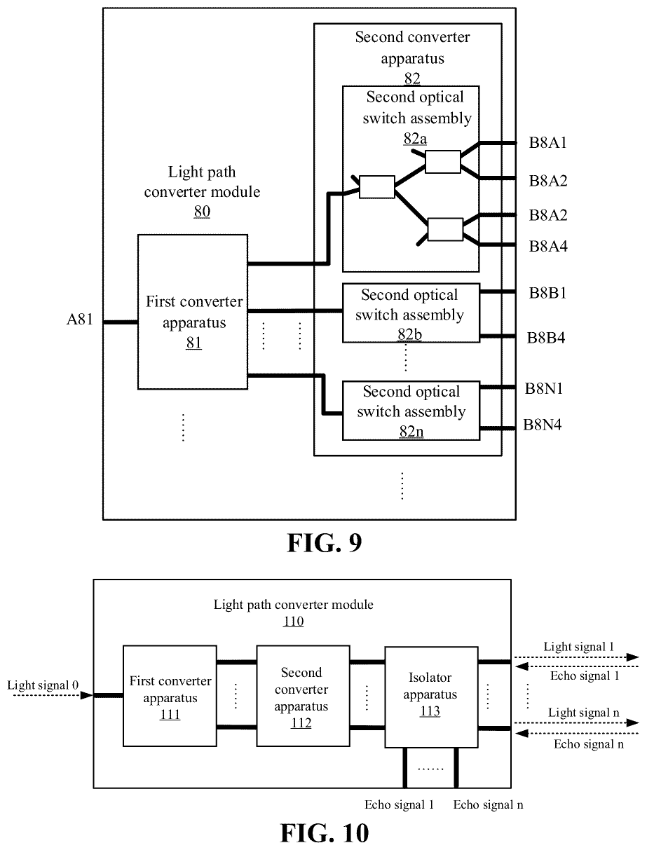

In some embodiments, the second converter apparatus can include multiple second optical switch assemblies. FIG. 9 shows a structural block diagram of a sixth example light path converter module, consistent with some embodiments of this disclosure. For example, as shown in FIG. 9, the light path converter module 80 can include a first converter apparatus 81 and a second converter apparatus 82. The description of the relevant portions can be referred to for a structure, a connection relationship, and an implementation principle of the first converter apparatus 81, which are not repeated here.

The light path converter module 80 can include a first port A81 and multiple second ports B8A1-B8A4 andB8B1-B8B2 to B8N1-B8N4. The first port A81 corresponds to the first converter apparatus 81; the first converter apparatus 81 is coupled to the second converter apparatus 82; and the second converter apparatus 82 corresponds to the second ports B8A1-B8A4 and B8B1-B8B2 to B8N1-B8N4.

The second converter apparatus 82 can include multiple second optical switch assemblies 82a to 82n. A second optical switch assembly of the multiple second optical switch assemblies 82a to 82n can include multiple second transmission paths. For example, the second optical switch assembly 82a includes a first stage optical switch and two second stage optical switches, thereby forming four second transmission paths. The structure of the second optical switch assembly 82a can be referred to for the structures of other second optical switch assemblies, which are not repeated here.

The second transmission paths of the second optical switch assemblies 82a to 82n can be located between the first converter apparatus 81 and the second ports B8A1-B8A4 and B8B1-B8B2 to B8N1-B8N4. The second optical switch assemblies 82a to 82n can allow the light signal to be transmitted along at least one of the second transmission paths. The relevant description of the first optical switch assembly can be referred to for an implementation principle of the second optical switch assemblies 82a to 82n, which is not repeated here.

Therefore, based on the number of light signal beams outputted from the first converter apparatus 81, the second converter apparatus 82 can increase the number of light signal beams by up to 4 times.

It is understandable that, in the examples, a secondary cascade structure of the second optical switch assembly is merely schematic description. In some practical application, the cascade structure can be changed based on application scenarios and requirements. This is not limited in this disclosure.

It is further understandable that, in the examples, the number of output terminals of the second optical switch assembly is 4, which is merely used for schematic description. In some practical application, an optical switch assembly with a required number of output terminals can be selected based on the application scenarios and requirements. In some embodiments, the multiple second optical switch assemblies can have different numbers of output terminals. This is not limited in this disclosure.

In some embodiments, to further increase the light signal intensity, the emitter module can further include an amplifier apparatus located between the light emitter module and the first converter apparatus. The amplifier apparatus can amplify the light signal outputted from the light emitter module and output the amplified light signal to the first converter apparatus.

In some embodiments, the light path converter module can determine one of the second ports for outputting the light signal based on a light path control signal. Therefore, the positions and the number of light signals outputted from the light path converter module can be changed based on the light path control signal. The light path control signal can be a signal generated by a control apparatus included in the light path converter module, or can be generated by a control module except for the light path converter module. This is not specifically limited in this disclosure.

In some embodiments, a receiving object and effects of a light path conversion control signal can be determined based on the structure of the light path converter module.

For example, an enhancement coefficient and an attenuation coefficient of each SOA in the light intensity regulator unit can be set or changed based on the light path conversion control signal. In such a case, the light intensity regulator unit can enhance a light signal of one or more corresponding channels and attenuate light signals of other light paths.

For another example, a state of each optical switch in the first optical switch assembly can be set or changed based on the light path conversion control signal. In such a case, the first optical switch assembly can perform path switching, the light signal can be transmitted along a required first transmission path.

In some practical application, a logic device, a logic circuit, or a combination of the two that generates the light path conversion control signal can be selected based on the application scenarios and requirements. The logic device can include: a processing chip, such as a Central Processing Unit (“CPU”), a Field Programmable Gate Array (“FPGA”), or the like, or can include an Application Specific Integrated Circuit (“ASIC”), or can further include one or more logical combination circuits configured to implement embodiments of this disclosure. This is not limited in this disclosure.

In some embodiments, the light path converter module can further include a third port configured to output local oscillator light. The local oscillator light can be partial light isolated from the light signal.

For example, the light path converter module can include a coupler apparatus configured to isolate partial light from the light signal for use as the local oscillator light. The described coupler apparatus can be set based on the application scenarios and requirements. For example, the coupler apparatus can be coupled to the light emitter module to isolate the local oscillator light from the light signal emitted from the light emitter module. The coupler apparatus can be further coupled to the first converter apparatus, and there can be one-to-one correspondence between the coupler apparatus and the output terminal of the first converter apparatus to isolate the local oscillator light from the light signal outputted from the first converter apparatus. The coupler apparatus can be further coupled to the second converter apparatus, and there can be one-to-one correspondence between the coupler apparatus and the output terminal of the second converter apparatus to isolate the local oscillator light from the light signal outputted from the second converter apparatus. The settings for isolation of the local oscillator light are not specifically limited in this disclosure.

There is one-to-one correspondence between input terminals of the coupler apparatus and the light signals of the partial light to be isolated by the coupler apparatus. There is one-to-one correspondence between output terminals of the coupler apparatus and the third ports.

In some practical application, devices specifically included in the coupler apparatus and the number of the devices can be selected based on the application scenarios and requirements.

For example, the coupler apparatus can include couplers, and the number of the couplers is equal to the number of the light signals. This is not limited in this disclosure.

In some embodiments, the second ports of the light path converter module are further configured to receive an echo signal of the light signal reflected from an obstacle. For example, a given second port can emit a light signal and receive a corresponding echo signal. In such a case, a coaxial light path can be formed.

In some embodiments, the light path converter module can further include fourth ports. The fourth ports can output the corresponding echo signal of the light signal. The number of the fourth ports can be equal to the number of the second ports.

In some embodiments, the light path converter module can further include an isolator apparatus, which can optically isolate the light signal and the echo signal of the light signal reflected from the obstacle. In such a case, the light signal can be outputted from the second port and the echo signal can be outputted from the fourth port.

Isolation of a light receiving path from a light emitting path of the coaxial light path can be provided.

FIG. 10 shows a structural block diagram of a seventh example light path converter module, consistent with some embodiments of this disclosure. For example, with reference to FIG. 10, the light path converter module 110 can include a first converter apparatus 111, a second converter apparatus 112, and an isolator apparatus 113. After receiving a light signal 0 emitted from the light emitter module through the first port, the light path converter module 110 outputs a light signal 1 from the second port through the first converter apparatus 111, the second converter apparatus 112, and the isolator apparatus 113. The isolator apparatus 113 can further receive a corresponding echo signal 1 of the light signal 1 through the second port. The isolator apparatus 113 can perform light path isolation on the light signal 1 and the echo signal 1. The isolator apparatus 113 can output the echo signal 1 from the fourth port of the light path converter module 110.

In some practical application, devices with isolation effects included in the isolator apparatus and the number of the devices can be selected based on application scenarios and requirements. For example, the isolator apparatus can include at least one of a circulator or a polarization beam splitter (“PBS”). The total number of devices can be equal to the number of the second ports. For example, when the isolator apparatus is the PBS, the PBS can directly transmit P light and deflect S light. When a probe laser signal is P light, the probe laser signal can be directly transmitted through the PBS and be emitted. An echo signal reflected from an obstacle can be mode converted into S light. In such a case, the PBS can deflect its light path and isolates it from the probe laser signal. The circulator has no requirements for a polarization state of the light signal. Those skilled in the art can select and set the isolator apparatus based on the application scenarios and requirements. This is not specifically limited in this disclosure.

In some embodiments, a spacing between the second ports can be set based on the application scenarios and requirements. For example, the second ports can be equally spaced to achieve a uniform angular resolution.

For another example, the second ports can be non-equally spaced. For example, in the light path converter module, a spacing between adjacent second ports located in the center region can be smaller than a spacing between adjacent second ports located in an edge region. Therefore, after the light signal outputted from the second port is collimated through the emitting optical component and emitted, an angle between two adjacent light signal beams in the center region can be smaller than an angle between two adjacent light signal beams in the edge region, and an angular resolution of the center region can be higher than an angular resolution of the edge region. The center region and the edge region can be changed and determined based on the scenarios. This is not specifically limited in this disclosure.

In some automatic control application scenarios, within a field range of the FMCW LiDAR, obstacles can be mainly distributed in the center region of the field range (e.g., in an autonomous driving application scenario, the FMCW LiDAR is typically installed on the roof or in the front of a vehicle, and the obstacles are mainly distributed near a horizontal plane within the field range). In such a case, the spacing between the adjacent second ports in the center region can be smaller than the spacing between the adjacent second ports in the edge region. An angle between probe laser signals emitted from the LiDAR can be changed. An angle between two adjacent probe laser signal beams in the center region can be smaller than an angle between two adjacent probe laser signal beams in the edge region. More probe laser signals can be concentrated in the center region (e.g., the horizontal plane) of the field range of the LiDAR without further increasing the number of second ports. The angular resolution of the center region can be higher than the angular resolution of the edge region. A laser beam density in the Region of Interest (“ROI”) can be increased and be more suitable for the autonomous driving application scenario.

It is understandable that the described embodiments provide various embodiments, and the embodiments can be combined and cross-referenced with each other on a non-conflict basis. Various possible embodiments can be extended, which can all be considered as embodiment solutions disclosed in embodiments of this disclosure.

This disclosure further provides a FMCW LiDAR corresponding to the light path converter module described in any of the above-mentioned embodiments, which is introduced in detail below with reference to the drawings based on some embodiments. It is necessary to know that the content of the FMCW LiDAR described below and the content of the light path converter module described can be referenced with each other accordingly.

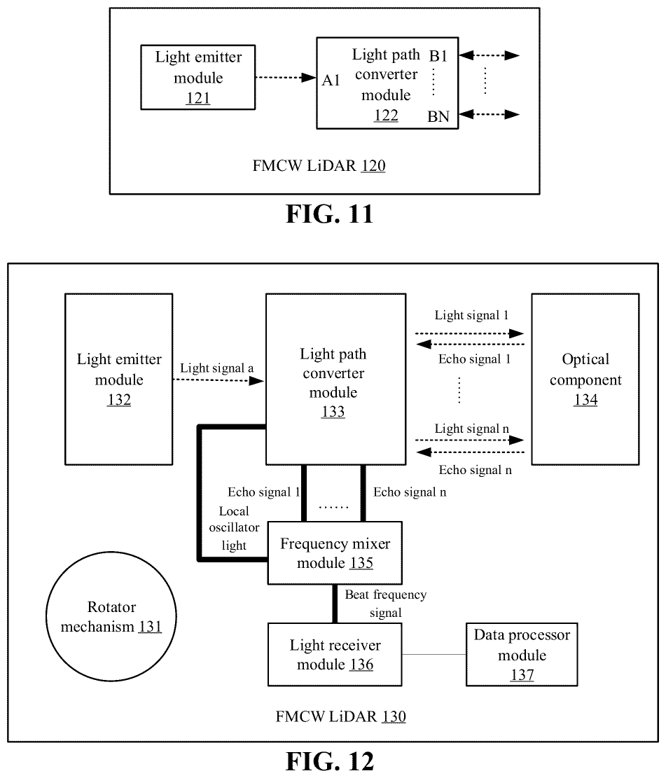

FIG. 11 shows a structural block diagram of a first example FMCW LiDAR, consistent with some embodiments of this disclosure. In some embodiments, as shown in FIG. 11, the FMCW LiDAR 120 can include a light emitter module 121 and a light path converter module.

The light emitter module 121 can emit a light signal. The light signal is frequency modulated continuous laser.

The light path converter module 122 is coupled to the light emitter module 121. The light path converter module 122 can receive the light signal and select one or more second ports for outputting the light signal. It is understandable that the relevant description and drawings can be referred to for a function, an implementation method, and a structure of the light path converter module 122, which are not repeated here.

As can be seen from the contents, the light path converter module provided in the embodiments of this disclosure can flexibly convert a light path of the light signal. In such a case, the FMCW LiDAR has an ability to output multichannel light signals, and can be changed based on the requirements for the number of beams. The diversity and universality of the number of beams of the FMCW LiDAR can be improved. Further, the structure of the light emitter module can remain unchanged, and light path conversion can be performed through the light path converter module. A smaller number of light emitter modules can be used in the FMCW LiDAR, to achieve more types of beam detection. In some embodiments, not only the number of beams of the FMCW LiDAR can be increased, but also hardware costs of the FMCW LiDAR can be effectively reduced.

The FMCW LiDAR using the described light path converter module can flexibly change the number and positions of light signals outputted within a detection cycle. Various requirements for the number of beams can be satisfied, and the hardware costs while increasing the number of beams can be effectively reduced.

In some embodiments, a conversion frequency on the light path converter module (e.g., a frequency of changing different second ports by the light path converter module within a single detection cycle of the FMCW LiDAR) can be configured based on at least one of a frame rate or point frequency of the FMCW LiDAR.

In some embodiments, based on the detection mode, the FMCW LiDAR can be divided into a mechanical rotating FMCW LiDAR and a solid-state scanning FMCW LiDAR.

Based on the structure of the light path converter module and the detection method for the FMCW LiDAR, other functional modules can be configured for the FMCW LiDAR. The functional modules can include an optical component, a frequency mixer module, a light receiver module, a data processor module, an isolator module, a coupler module, a rotator mechanism, a scanner module, or the like. To enable those skilled in the art to more clearly understand and implement the technical solutions of the FMCW LiDAR, schematic description is provided below with reference to the drawings.

FIG. 12 shows a structural block diagram of a second example FMCW LiDAR, consistent with some embodiments of this disclosure. In an optional example, referring to FIG. 12, the mechanical rotating FMCW LiDAR 130 can include a rotator mechanism 131, a light emitter module 132, a light path converter module 133, an optical component 134, a frequency mixer module 135, a light receiver module 136, and a data processor module 137.

The rotator mechanism 131 can drive the FMCW LiDAR 130 to rotate.

The light emitter module 132 can emit a light signal. The light signal is frequency modulated continuous laser.

The light path converter module 133 can receive the light signal through a first port, select one or more second ports for outputting the light signal, receive a corresponding echo signal of the light signal through the second port; output light oscillator light through a third port; and output the echo signal through a fourth port.

The optical component 134 can shape (e.g., collimate or converge, or the like) the light signal and the echo signal. The shaped light signal can be emitted to a target space to detect an obstacle in the target space. The shaped echo signal can be transmitted to the light path converter module 133.

The frequency mixer module 135 can mix the local oscillator light with the echo signal to obtain a beat frequency signal. There is one-to-one correspondence between the frequency mixer module 135 and the second ports of the light path converter module 133.

The light receiver module 136 can perform photoelectric conversion on the beat frequency signal.

The data processor module 137 can perform sampling and data processing on an electrical signal outputted from the light receiver module 136.

For example, when the light path converter module 133 sequentially outputs a mono-channel light signal, the light emitter module 132 can emit a light signal a, the light path converter module 133 can sequentially output a light signal 1 to a light signal n to the optical component 134, and output local oscillator light to the frequency mixer module 135. Through the optical component 134, the light path converter module 133 can sequentially receive a corresponding echo signal 1 of the light signal 1 to a corresponding echo signal n of the light signal n. Then the light path converter module 133 can sequentially output the echo signal 1 to the echo signal n to the frequency mixer module 135. The frequency mixer module 135 can sequentially mix the echo signal 1 to the echo signal n with the local oscillator light to obtain a beat frequency signal 1 to a beat frequency signal n. The light receiver unit 136 can sequentially perform photoelectric conversion on the beat frequency signal 1 to the beat frequency signal n, and output a corresponding electrical signal of the beat frequency signal 1 to a corresponding electrical signal of the beat frequency signal n to the data processor module 137.

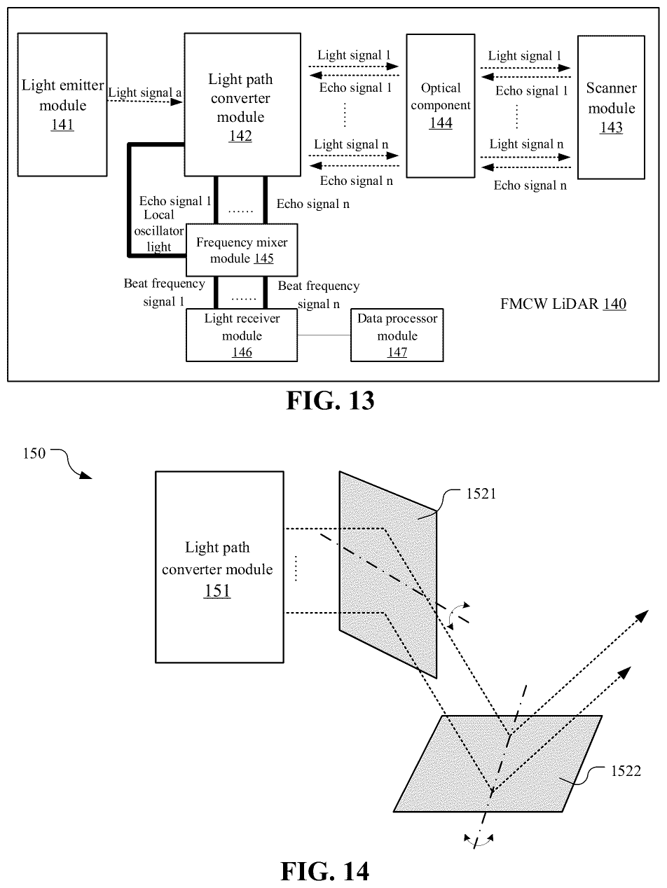

In some embodiments, referring to FIG. 13, the solid-state scanning FMCW LiDAR 140 includes a light emitter module 141, a light path converter module 142, an optical component 143, a scanner module 144, a frequency mixer module 145, a light receiver module 146, and a data processor module 147.

The light emitter module 141 can emit a light signal. The light signal can be frequency modulated continuous laser.

The light path converter module 142 can receive the light signal through a first port, select one or more second ports for outputting the light signal, and receive a corresponding echo signal of the light signal through the second port. The light path converter module 142 can output light oscillator light through a third port. The light path converter module 142 can output the echo signal through a fourth port.

The optical component 143 can perform light path shaping (e.g., collimation or convergence, or the like) on the light signal and the echo signal. The shaped light signal can be transmitted to the scanner module 144. The shaped echo signal can be transmitted to the light path converter module 142.

The scanner module 144 can reflect the light signal, emit the light signal towards a target space to detect an obstacle in the target space, and reflect the echo signal to the optical component 143. The scanner module 143 can rotate along a same direction, or can swing back and forth within a certain angle range. In such a case, the light signal can scan at least in a second direction. There can be an angle between the first direction and the second direction.

The frequency mixer module 145 can mix the local oscillator light with the echo signal to obtain a beat frequency signal. There can be one-to-one correspondence between the frequency mixer module 145 and the third ports of the light path converter module 142.

The light receiver module 136 can perform photoelectric conversion on the beat frequency signal.

The data processor module 137 can perform sampling and data processing on an electrical signal outputted from the light receiver module 136.

FIG. 12 and the relevant description can be referred to for signal flow between the light emitter module 141, the light path converter module 142, the scanner module 143, the optical component 144, the frequency mixer module 145, the light receiver module 146, and the data processor module 147, which are not repeated here.

In some embodiments, devices included in each module of the FMCW LiDAR can be selected based on application scenarios and requirements. For example, the light receiver module can include multiple light receiver apparatuses, and the light receiver apparatuses can include photo diodes (“PD”). The data processor module can include an analog-to-digital converter (“ADC”), a filter, a processing chip, or the like. The frequency mixer module can include multiple frequency mixers. The optical component can include at least one of a collimating mirror or a microlens.

In some embodiments, the number and a corresponding relationship of devices included in each module of the FMCW LiDAR can be determined based on the application scenarios and requirements. For example, the number of light receiver apparatuses included in the light receiver module can be not less than the number of second ports. After the light signal outputted from the second port is reflected from the obstacle, the corresponding echo signals can all be received and processed. There can be one-to-one correspondence between the multiple light receiver apparatuses and the multiple second ports through the frequency mixer module. For another example, the number of the frequency mixers included in the frequency mixer module can be not less than the number of the fourth ports. In such a case, detection signals outputted from the fourth ports can be mixed with the local oscillator light to obtain corresponding beat frequency signals.

It should be noted that a structure and the number of devices of each module is not limited in this disclosure.

In some embodiments, a rotation direction of the scanner module can be set based on the application scenario and requirements.

In some embodiments, the scanner module can include a two-dimensional scanner apparatus. The two-dimensional scanner apparatus can rotate along a first rotation axis at a first frequency and rotate around a second rotation axis at a second frequency.

In some embodiments, the scanner module includes two one-dimensional scanner apparatuses. One one-dimensional scanner apparatus can rotate around the first rotation axis at the first frequency. The other one-dimensional scanner apparatus can rotate along the second rotation axis at the second frequency.

The first direction can be perpendicular to the first rotation axis, and the second direction can be perpendicular to the second rotation axis.

In some embodiments, the scanner module can include a one-dimensional scanner apparatus that rotates around a third rotation axis at a third frequency. The rotation axis of the one-dimensional scanner apparatus can be parallel to the first direction, or there can be a certain angle between the rotation axis of the one-dimensional scanner apparatus and the first direction. Further, the angle between the third rotation axis and the first direction can be changed based on the application scenarios and requirements. For example, the angle change can range from 0° to 45°.

In some embodiments, the two-dimensional scanner apparatus and the one-dimensional scanner apparatus can each select a scanner device included therein based on the application scenarios and requirements. For example, the two-dimensional scanner apparatus can include at least one of an oscillating mirror or a rotating mirror. The one-dimensional scanner apparatus can include at least one of an oscillating mirror, a rotating mirror, or a prism. It is understandable that the two-dimensional scanner apparatus and the one-dimensional scanner apparatus can further include other components configured to the scanner device, such as a driver unit that rotates the scanner device. This is not specifically limited in this disclosure.

To facilitate those skilled in the art to understand and implement the scanning and rotating FMCW LiDAR, schematic description is provided below with reference to the drawings.

FIG. 14 shows a schematic diagram of internal light path deflection of a scanning and rotating FMCW LiDAR, consistent with some embodiments of this disclosure. It should be noted that, to facilitate understanding and description, some components (e.g., the light emitter module, the frequency mixer module, or the light receiver module) can be omitted in FIG. 14. In some practical application, the FMCW LiDAR needs to perform some light path processing and data processing to complete a detection task of a target space. This is not specifically limited in this disclosure.

Referring to FIG. 14, the FMCW LiDAR 150 can include a light path converter module 151 and a scanner module. The light path converter module 151 can include multiple perpendicularly distributed second ports. The scanner module can include two one-dimensional scanner apparatuses 1521 and 1522.

The light path converter module 151 can select at least one of the second ports in a predetermined sequence, for outputting a light signal. The relevant content can be referred to for a structure, a function, and an implementation of the light path converter module 151, which are not repeated here.

The one-dimensional scanner apparatus 1521 can rotate around a horizontal first rotation axis at a first frequency, the one-dimensional scanner apparatus 1522 can rotate around a horizontal second rotation axis at a second frequency; and there is an angle between the first rotation axis and the second rotation axis.

Therefore, through the reflection from the one-dimensional scanner apparatuses 1521 and 1522, the light signal is deflected in two dimensions. In such a case, the FMCW LiDAR can perform two-dimensional scanning on the target space.

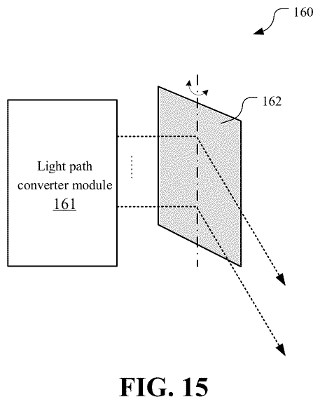

FIG. 15 shows a schematic diagram of internal light path deflection of another scanning and rotating FMCW LiDAR, consistent with some embodiments of this disclosure. It should be noted that, to facilitate understanding and description, some components (e.g., the light emitter module, the frequency mixer module, or the light receiver module) are omitted in FIG. 15. In some practical application, the FMCW LiDAR needs to perform some light path processing and data processing to complete a detection task of a target space. This is not specifically limited in this disclosure.

Referring to FIG. 15, the FMCW LiDAR 160 can include a light path converter module 161 and a scanner module. The light path converter module 161 can include multiple second ports along a first direction. The scanner module can include a one-dimensional scanner apparatus 162. The one-dimensional scanner apparatus 162 can rotate about a perpendicular third rotation axis at a third frequency.

The light path converter module 161 can select at least one of the second ports in a predetermined sequence, for outputting a light signal. The relevant content can be referred to for a structure, a function, and an implementation of the light path converter module 161, which are not repeated here.

The light signal is deflected through reflection from the one-dimensional scanner apparatus 162, and the one-dimensional scanner apparatus 162 is at different angles at different time points. In such a case, the light signal can be deflected in two dimensions, and the FMCW LiDAR can perform two-dimensional scanning on the target space.

In some embodiments, to adapt to multichannel output of light signals from the light path converter module, the light receiver module can typically include multiple light receiver apparatuses to ensure that multichannel beat frequency signals can be photoelectrically converted. If the light path converter module only uses some of the ports for outputting the light signal during a single emission, some devices of the data processor module can be multiplexed through signal switching. In such a case, hardware costs of the FMCW LiDAR can further reduced.

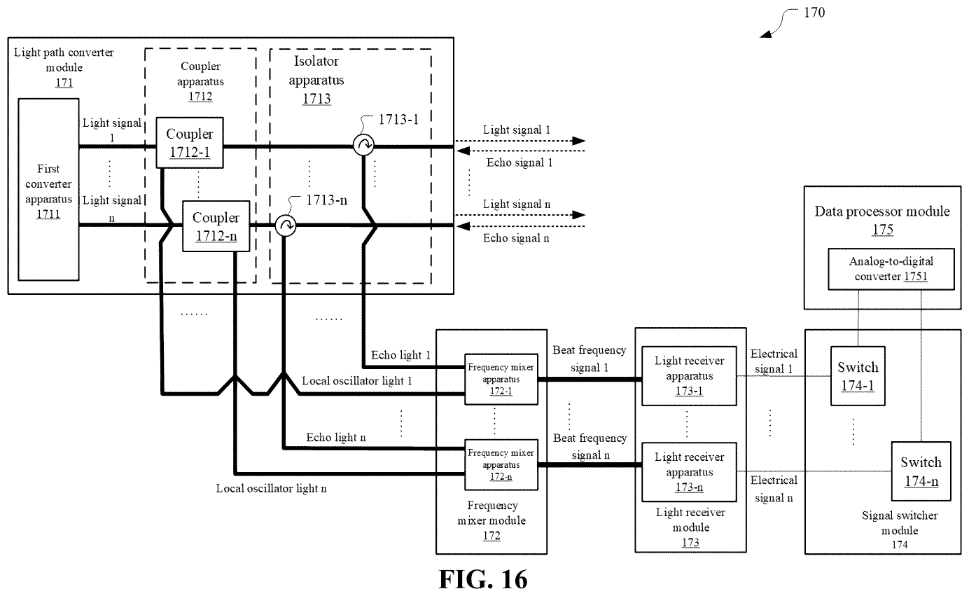

FIG. 16 shows a structural block diagram of another FMCW LiDAR, consistent with some embodiments of this disclosure. In some embodiments, as shown in FIG. 16, the FMCW LiDAR 170 can include a light path converter module 171, a frequency mixer module 172, a light receiver module 173, a signal switcher module 174, and a data processor module 175.

It should be noted that, to facilitate understanding and description, some components (e.g., the light emitter module or the optical component) are omitted in FIG. 16. In some practical application, the FMCW LiDAR needs to perform some light path processing to complete a detection task of a target space. This is not specifically limited in this disclosure.

The light path converter module 171 includes a first converter apparatus 1711, a coupler apparatus 1712, and an isolator apparatus 1713. The coupler apparatus 1712 can include multiple couplers 1712-1 to 1712-n; and the isolator apparatus 1713 can include multiple isolators 1713-1 to 1713-n. The isolator apparatus can include the isolators 1713-1 to 1713-n.

The relevant description can be referred to for some structures, a connection relationship, and implementation principles of the light path converter module 171, the frequency mixer module 172, the light receiver module 173, and the data processor module 175, which are not repeated here.

The signal switcher module 174 can be located between the light receiver module 173 and the data processor module 175. Based on the second port selected by the light path converter module 171, a path between the light receiver apparatus corresponding to the second port and the data processor module 175 can be switched on. In such a case, the electrical signal generated by the light receiver apparatus can be transmitted to the data processor module 175.

The frequency mixer module 172 can include frequency mixer apparatuses 172-1 to 172-n. The light receiver module 173 can include light receiver apparatuses 173-1 to 173-n. The signal switcher module 174 includes switches 174-1 to 174-n. The data processor module 175 can include an analog-to-digital converter 1751.

For example, the first converter apparatus 1711 can sequentially output light signals 1 to n. When the first converter apparatus 1711 outputs the light signal 1, the light signal 1 can be outputted sequentially through the coupler 1712-1 and the isolator 1713-1.

The coupler 1712-1 can isolate partial light from probe laser 1 for use as local oscillator light 1, and output the local oscillator light to the frequency mixer apparatus 172-1. When the isolator 1713-1 receives a corresponding echo signal 1 of the light signal 1, the echo signal 1 can be transmitted to the frequency mixer apparatus 172-1 through the isolator 1713-1. The frequency mixer apparatus 172-1 can mix the local oscillator light 1 with the echo signal 1 to obtain a beat frequency signal 1, and input the beat frequency signal into the light receiver apparatus 173-1.

The light receiver apparatus 173-1 can perform photoelectric conversion on the beat frequency signal 1 to obtain a corresponding electrical signal 1. The signal switcher module 174 performs path switching and switches on a switch 174-1 corresponding to the light receiver apparatus 173-1. In such a case, the electrical signal 1 can be transmitted to the data processor module 175. The analog-to-digital converter 1751 of the data processor module 175 can perform a sampling operation on the electrical signal 1.

Based on the content, sequential output of several other light signal beams from the light path converter module 171 can be inferred, which is not repeated here. In such a case, the analog-to-digital converter 1751 of the data processor module 175 can be multiplexed, the number of analog-to-digital converters can be reduced, and the costs can be reduced.

The signal switcher module can determine a switch to be switched on based on a switching control signal, where the switching control signal can be a signal generated by a control apparatus included in the signal switcher module, or can be a signal generated by a control module except for the signal switcher module. This is not specifically limited in this disclosure.

It is understandable that the examples are merely schematic description. In some practical application, devices included in the signal switcher module can be selected based on application scenarios and requirements. For example, the signal switcher module can include an analog switch, or the like. This is not specifically limited in this disclosure.

It is understandable that the described embodiments provide various embodiments, and the embodiments can be combined and cross-referenced with each other on a non-conflict basis. In such a case, various possible embodiments can be extended, which can all be considered as embodiment solutions disclosed in embodiments of this disclosure.

This disclosure further provides a detection method corresponding to the above-mentioned FMCW LiDAR, which is introduced in detail below with reference to the drawings based on some embodiments. It is necessary to know that the content of the detection method described below and the content of the FMCW LiDAR described above can be referenced with each other accordingly.

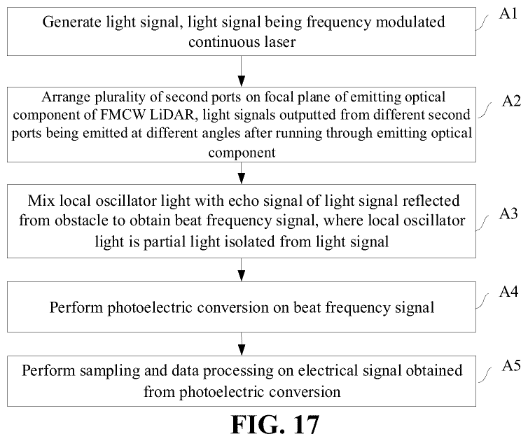

In some embodiments, as shown in FIG. 17, a flowchart of a detection method in this embodiment is shown. Referring to FIG. 17, the detection method can include the following steps.

At A1), a light signal is generated, the light signal being frequency modulated continuous laser.

At A2), at least one is selected from multiple second ports to output the light signal. The second ports are distributed at least along a first direction. The multiple second ports are arranged on a focal plane of an emitting optical component of the FMCW LiDAR, light signals outputted from different second ports are emitted at different angles after running through the emitting optical component.

At A3), local oscillator light with an echo signal of the light signal reflected from an obstacle is mixed to obtain a beat frequency signal, where the local oscillator light is partial light isolated from the light signal.

At A4), photoelectric conversion on the beat frequency signal is performed.

At A5), sampling and data processing is performed on an electrical signal obtained from the photoelectric conversion.

The number and positions of light signals outputted within a detection cycle can be flexibly changed. In such a case, various requirements for the number of beams can be satisfied and the hardware costs can be effectively reduced while increasing the number of beams.

In some embodiments, between the step A2) and the step A3), the laser detection method can further include B1). At B1), the light signal is deflected in at least a second direction and the light signal is outputted to the target space, where there is an angle between the first direction and the second direction.

In some embodiments, the laser detection method can further include C1). At C1), a conversion frequency of the light signal is configured based on a preset angular resolution and a scanning frequency of the FMCW LiDAR.

The step C1) can be executed before the FMCW LiDAR is started, or can be executed after at least one of the angular resolution or the scanning frequency of the FMCW LiDAR is modified. The practical execution of the step C1) is not specifically limited in this disclosure.

It should be noted that, the terms such as “first” and “second” in embodiments of this disclosure are only used for the purpose of description, and cannot be understood as indicating or implying relative importance or implicitly indicating the number of indicated technical features. Thus, features defined with the terms such as “first” or “second” can explicitly or implicitly include one or more of the features. Further, the terms such as “first” and “second” are used to distinguish between similar objects, and are not necessarily used to describe a particular sequence or indicate importance.

Although the embodiments of this disclosure are disclosed, this disclosure is not limited to the above embodiments. Any person skilled in the art can make various alterations and modifications without departing from the spirit and scope of this disclosure. Therefore, the protection scope of this disclosure should be subject to the scope defined by the claims.

What is claimed is:

1. A light path converter module for a FMCW LiDAR, being coupled to a light emitter module and configured to receive and output a light signal emitted from the light emitter module, the light signal being frequency modulated continuous laser, wherein the light path converter module comprises: at least one first port and a plurality of second ports; wherein
the at least one first port is coupled to the light emitter module;
the plurality of second ports are distributed at least along a first direction and are arranged on a focal plane of an emitting optical component of the FMCW LiDAR, light signals outputted from different second ports being emitted at different angles after running through the emitting optical component; and
the light path converter module is configured to receive the light signal inputted from the first port and select one or more of the second ports for outputting the light signal.

2. The light path converter module for a FMCW LiDAR of claim 1, wherein the light path converter module comprises a first converter apparatus configured to perform one-port output or multiport output on the light signal emitted from the light emitter module.

3. The light path converter module for a FMCW LiDAR of claim 2, wherein the first converter apparatus comprises a first light splitter unit; the first light splitter unit comprises: a first input terminal corresponding to the first port and a plurality of first output terminals, and is configured to split the light signal into multiple channels and output them from the plurality of first output terminals respectively.

4. The light path converter module for a FMCW LiDAR of claim 3, wherein there is one-to-one correspondence between the first output terminals and the second ports.

5. The light path converter module for a FMCW LiDAR of claim 3, wherein the first converter apparatus further comprises: a light intensity regulator unit, wherein
the light intensity regulator unit is coupled to the plurality of first output terminals, and is configured to enhance probe laser outputted from at least one of the first output terminals or attenuate probe laser outputted from other first output terminals.

6. The light path converter module for a FMCW LiDAR of claim 5, wherein the light intensity regulator unit comprises a semiconductor optical amplifier.

7. The light path converter module for a FMCW LiDAR of claim 2, wherein the first converter apparatus comprises a first optical switch assembly; the first optical switch assembly comprises a plurality of first transmission paths located between the first port and the second ports; and the first optical switch assembly is configured to transmit the light signal along at least one of the first transmission paths.

8. The light path converter module for a FMCW LiDAR of claim 2, wherein the light path converter module further comprises a second converter apparatus configured to perform one-port output or multiport output on the light signal outputted from the first converter apparatus.

9. The light path converter module for a FMCW LiDAR of claim 8, wherein the second converter apparatus comprises a second light splitter unit, the second light splitter unit comprises: a second input terminal and a plurality of second output terminals; the second input terminal is coupled to the first converter apparatus, and the plurality of second output terminals correspond to the plurality of second ports respectively; and the second light splitter unit is configured to split the received light signal into a plurality of channels, and output them from the plurality of second output terminals respectively.

10. The light path converter module for a FMCW LiDAR of claim 8, wherein the second converter apparatus comprises: a second optical switch assembly; the second optical switch assembly comprises a plurality of second transmission paths located between the first converter apparatus and the second ports; and the second optical switch assembly is configured to transmit the light signal along at least one of the second transmission paths.

11. The light path converter module for a FMCW LiDAR of claim 2, wherein the light path converter module further comprises: an amplifier apparatus located between the light emitter module and the first converter apparatus, and is configured to amplify the light signal outputted from the light emitter module, and output the amplified light signal to the first converter apparatus.

12. The light path converter module for a FMCW LiDAR of claim 1, wherein the light path converter module is further configured to determine one of the second ports for outputting the light signal based on a light path control signal.

13. The light path converter module for a FMCW LiDAR of claim 1, wherein the second ports of the light path converter module are further configured to receive an echo signal of the light signal reflected from an obstacle.

14. The light path converter module for a FMCW LiDAR of claim 1, wherein the second ports are equally spaced.

15. The light path converter module for a FMCW LiDAR of claim 1, wherein the second ports are non-equally spaced.

16. The light path converter module for a FMCW LiDAR of claim 15, wherein in the light path converter module, a spacing between adjacent second ports located in the center region is smaller than a spacing between adjacent second ports located in an edge region.

17. A FMCW LiDAR, comprising:
a light emitter module configured to emit a light signal, the light signal being frequency modulated continuous laser; and
the light path converter module of claim 1 coupled to the light emitter module, and is configured to receive the light signal and select one or more second ports for outputting the light signal.

18. The FMCW LiDAR of claim 17, wherein a conversion frequency of the light path converter module is configured based on a preset angular resolution and a scanning frequency of the FMCW LiDAR.

19. The FMCW LiDAR of claim 17, wherein the FMCW LiDAR further comprises:
a frequency mixer module configured to mix local oscillator light with an echo signal of the light signal reflected from an obstacle to obtain a beat frequency signal, wherein the local oscillator light is partial light isolated from the light signal;
a light receiver module configured to perform photoelectric conversion on the beat frequency signal; and
a data processor module configured to perform sampling and data processing on an electrical signal outputted from the receiver module.

20. The FMCW LiDAR of claim 19, wherein there is one-to-one correspondence between the frequency mixer module and the second ports of the light path converter module.

21. The FMCW LiDAR of claim 19, wherein the FMCW LiDAR further comprises: a scanner module configured to reflect the light signal, and reflect the echo signal to the light path converter module.

22. The LiDAR of claim 21, wherein the scanner module deflects the light signal in at least a second direction, and there is an angle between the first direction and the second direction.

23. The FMCW LiDAR of claim 22, wherein the scanner module comprises at least one of:
a two-dimensional scanner apparatus configured to rotate along a first rotation axis at a first frequency, and rotate around a second rotation axis at a second frequency; or
two one-dimensional scanner apparatuses, one of which is configured to rotate around the first rotation axis at the first frequency and the other one of which rotates along the second rotation axis at the second frequency;
wherein the first direction is perpendicular to the first rotation axis, and the second direction is perpendicular to the second rotation axis.

24. The FMCW LiDAR of claim 22, wherein the scanner module comprises a one-dimensional scanner apparatus that rotates around a third rotation axis at a third frequency.

25. The FMCW LiDAR of claim 24, wherein the third rotation axis is parallel to the first direction.

26. A detection method for a FMCW LiDAR, comprising:
generating a light signal, the light signal being frequency modulated continuous laser;
selecting at least one from a plurality of second ports to output the light signal; wherein the second ports are distributed at least along a first direction; and the plurality of second ports are arranged on a focal plane of an emitting optical component of the FMCW LiDAR, light signals outputted from different second ports being emitted at different angles after running through the emitting optical component;
mixing local oscillator light with an echo signal of the light signal reflected from an obstacle to obtain a beat frequency signal, wherein the local oscillator light is partial light isolated from the light signal;
performing photoelectric conversion on the beat frequency signal; and
performing sampling and data processing on an electrical signal obtained from the photoelectric conversion.

27. The detection method for a FMCW LiDAR of claim 26, wherein the detection method further comprises:
deflecting the light signal in at least a second direction, and outputting the light signal to a target space; wherein there is an angle between the first direction and the second direction.

28. The detection method for a FMCW LiDAR of claim 26, wherein the detection method further comprises:
configuring a conversion frequency of the light signal based on a preset angular resolution and a scanning frequency of the FMCW LiDAR.
